(19) United States
(12) Patent Application Publication
(10) Pub. No.: US 2016/0246925 A1
(43) Pub. Date: Aug. 25, 2016

(54) SYSTEM AND METHOD FOR OBTAINING AND TRANSMITTING BRIEF PATIENT NOTES

(71) Applicant: APPLIED RESEARCH WORKS Inc., PALO ALTO, CA (US)

(72) Inventors: SHAIBAL ROY, PALO ALTO, CA (US); Rupinder Singh, MOUNTAIN VIEW, CA (US); Amrita Pal, KOLKATA (IN)

(73) Assignee: APPLIED RESEARCH WORKS INC., Palo Alto, CA (US)

(21) Appl. No.: 14/627,148

(22) Filed: Feb. 20, 2015

(51) Int. Cl. G06F 19/00; G06Q 10/10

(52) U.S. Cl. CPC G06F 19/322; G06F 19/3418; G06Q 10/107

(57) ABSTRACT

Disclosed is a system and method for obtaining and transmitting brief patient notes over a computer network. In certain embodiments, the method comprises the steps of supplying an account in an electronic health record to a first user, providing health information about patients to the first user on a user interface, receiving a request to enter a brief patient note through the user interface, displaying a dialogue box through which the first user enters text to create a brief patient note, and storing the brief patient note on a central repository.

### BACKGROUND

In healthcare settings, it is customary to utilize an Electronic Health Record (EHR) to manage patient records and share data across numerous providers. Lacking in many existing EHR platforms, is the ability to annotate a given patient's medical record with information that may not properly exist in specific fields of the medical record, and transmit such information to specific healthcare providers. Disclosed is a system and method for annotating a given patient's medical record, and transmitting the annotation to specific healthcare providers.

### SUMMARY OF THE INVENTION

Disclosed is a system and method for obtaining and transmitting brief patient notes over a computer network. Users of an Electronic Health Record (EHR) may enter text a note into a given patient's record. Such notes may not have a specific place in the medical record. The note may be a reminder for the user creating the note, or it may be shared or transmitted to other users. The brief patient notes are stored on a central repository and accessed by specified users.

### BRIEF DESCRIPTION OF THE DRAWINGS

FIG. 1 illustrates an embodiment of a computer system, through which Brief Patient Notes may be added to an EHR and transmitted to one or more providers.

FIG. 2 illustrates an embodiment of a method for obtaining, storing, and transmitting a brief patient note.

FIG. 3 illustrates an embodiment of a user interface on an EHR through which a user may request the entry of a brief patient note.

FIG. 4 illustrates an embodiment of a user interface, displaying a dialogue box in which users will enter text, thereby creating a brief patient note.

### DETAILED DESCRIPTION

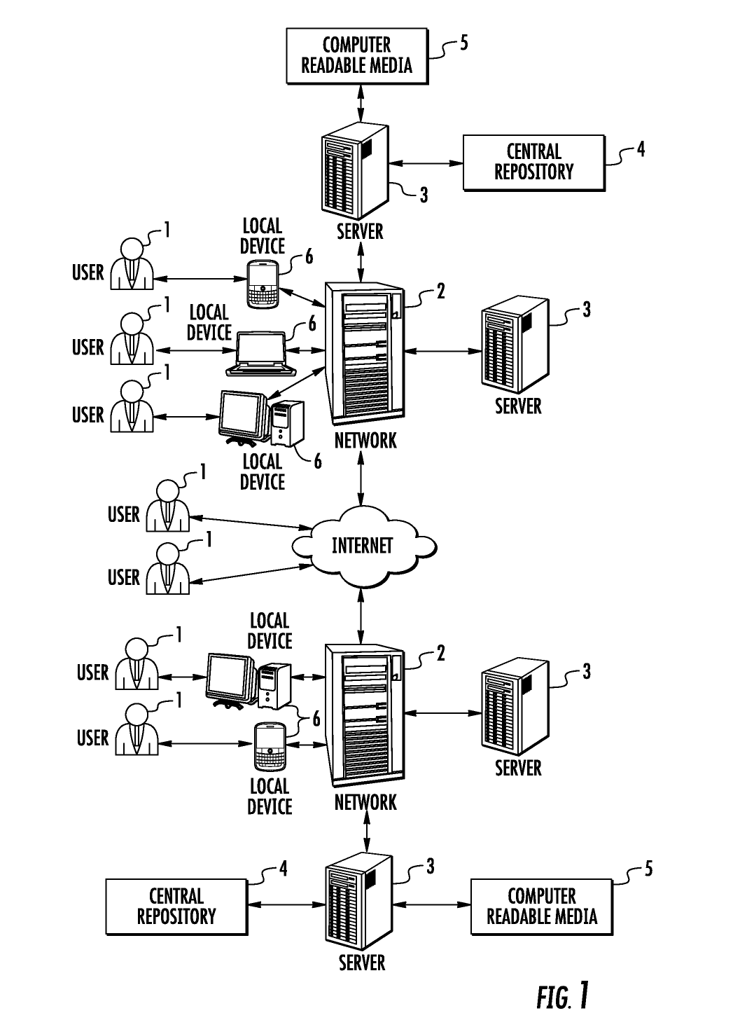

Disclosed is a system and method for sharing brief patient notes among users of an Electronic Medical Record (EHR), wherein the EHR is used for the storage, retrieval, and transmission of information in a healthcare setting. FIG. 1 illustrates a representative embodiment of the disclosed system. In certain embodiments, users 1 who share information over one or more internet based applications. Each user 1 is supplied with an account to access the EHR and the system. To access the system, each user must authenticate his or her identity. In certain embodiments, this authentication is performed by providing an assigned user name and password. In alternative embodiments, different or additional credentials may be required. Alternative embodiments comprise one or more networks 2, which may be optionally coupled to the Internet. In certain embodiments, each of the networks 2 will utilize various security features to ensure the security and integrity of the system and data transmitted over the system. In certain embodiments, each network 2 will utilize secure connections (for example, Secure Sockets Layer, Transport Layer Security, or Secure/Multipurpose Internet Mail Extensions). The system comprises one or more servers 3, each server 3 coupled to one or more networks 2. In certain embodiments, one or more servers 3 are coupled to the Internet. In certain embodiments, each server 3 will be protected by one or more firewalls. Further, data on each server may be encrypted. In certain embodiments, non-transitory computer readable media 5 encoding instructions for carrying out various methods is coupled to one or more servers 3. Users connect to the system servers through various devices 6 having connections to one or more networks 2, or the Internet. In alternative embodiments, users may access the system through local area networks, telephonic devices, radio frequencies, computers, or other electronic devices. In certain embodiments, data obtained through, and transmitted over the system resides on one or more central repositories 4. The one or more central repositories 4 may be associated with thin or thick clients where data transmitted through the system will be synchronized. In certain embodiments, all data transmitted and displayed to users resides on the central repository 4.

The system allows for brief patient notes (BPN) to be created by a user in an EHR. The BPN's may then be viewed by anyone accessing the medical record, or at the discretion of the user, only by specified providers having access to the EHR. In certain embodiments, the BPN's may be transmitted to specified providers using an existing mail in the form of email messages. Certain embodiments also enable users to view the BPN's as a message on a user interface (UI).

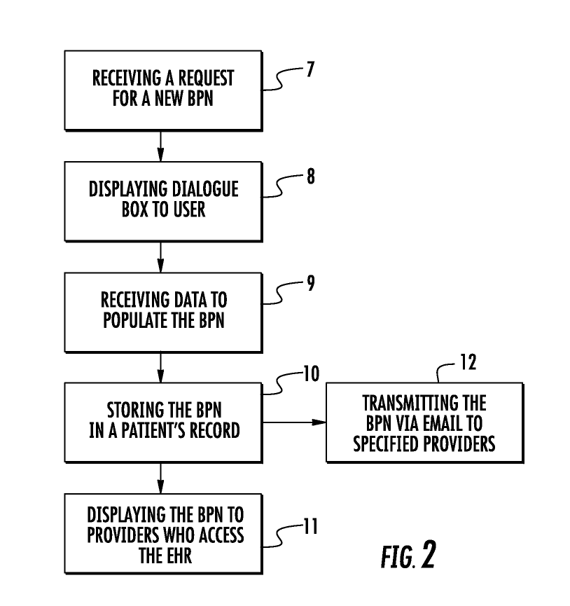

FIG. 2 illustrates an embodiment of a method for obtaining, storing, and transmitting a BPN. The disclosed method allows providers to share limited information with other healthcare providers by providing text that does not otherwise have an appropriate place in the medical record. By default, BPN's are only viewable by the user who created the BPN. However, certain embodiments of the method also allow the BPN to be shared only with specific providers, not all providers who may view the medical record.

The first step in the method is for the system to receive a request for a BPN 7. This request is received from a user through a user interface. Once the system received a request for a new BPN, a dialogue box is displayed to the user 8 who requested the BPN entry. The system then receives data to populate the BPN 9. The data is typically text, but may also comprise photographs, sounds or any other data in a digital format. The system then stores the BPN in the patient's record 11 for whom the BPN was entered. The BPN is then displayed to other providers who access the patient's record 11 through a user interface. Optionally, the BPN may be transmitted by the system to specified providers by email 12.

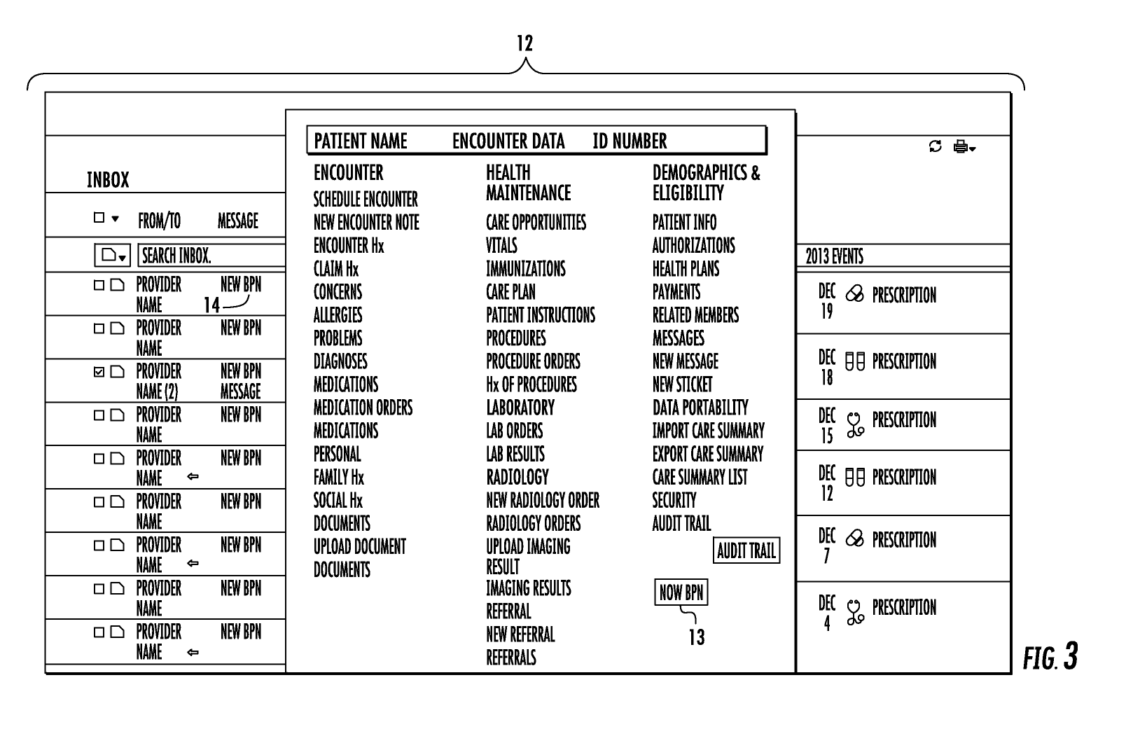

FIG. 3 illustrates an embodiment of a user interface 12 of an EHR wherein a user, typically a healthcare provider, may view and input health information pertaining to a given client. The dialogue box in the center of the screen allows a provider to select information to enter or view. Additionally may click “New BPN” 13 to create a new brief patient note. The user interface 13 illustrates new BPN's that have been created by other providers and made available to the user. The user interface also includes other health information, typically seen in an EHR.

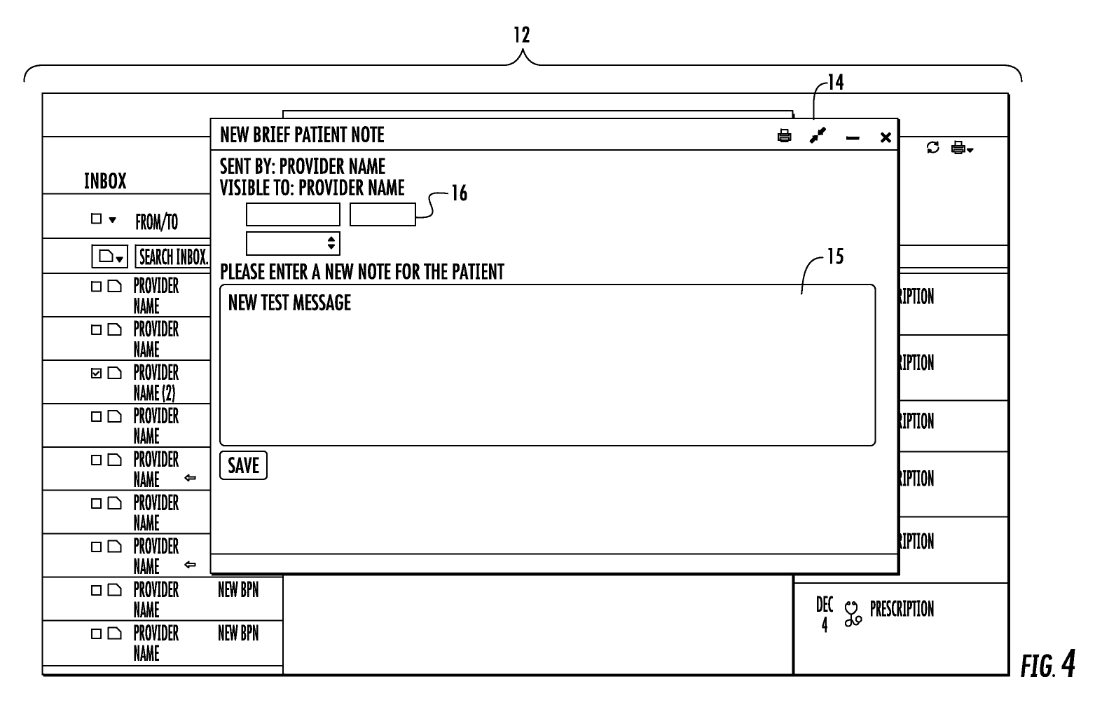

FIG. 4 illustrates a user interface that displays a dialogue box 14, where a user can populate a BPN with text. The system displays the dialogue box 14 after it receives the request form a user to create a new BPN. The dialogue box includes a section for the provider to enter text 15, and drop down menus 16 where a provider can select the other providers with whom the BPN will be shared.

When users create and access BPN's, a log is created by the system. The system logs the date and time each BPN was created, viewed or transmitted, and which user performed each action. This log is accessible to users who may access an audit log through the user interface.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable.

What is claimed is:

1. A method for obtaining and transmitting brief patient notes over a computer network comprising the steps of:
supplying an account in an electronic health record to a first user;
providing health information about patients to the first user through a user interface;
receiving a request to enter a brief patient note through the user interface;
displaying a dialogue box through which the first user enters text to create a brief patient note; and
storing the brief patient note on a central repository.

2. The method for obtaining and transmitting brief patient notes over a computer network of claim 1 further comprising steps of:
supplying an account in an electronic health record to one or more second users;
displaying one more second users to the first user;
receiving selections of the one or more second users from the first user; and
displaying the brief patient note to the one or more second users selected by the first user.

3. The method for obtaining and transmitting brief patient notes over a computer network of claim 2 further comprising step of transmitting the brief patient note to the one or more second users by email.

4. The method for obtaining and transmitting brief patient notes over a computer network of claim 2 further comprising steps of:
creating an audit log of each user who accesses the brief patient note;
storing the audit log on the central repository; and
displaying the audit log to first user through a user interface.

5. A system for obtaining and transmitting brief patient notes over a computer network comprising:
one or more servers coupled to one or more networks;
a central repository coupled to the one or more servers coupled to one or more networks; and
a non-transitory computer readable media coupled to one or more servers, where in the non-transitory computer readable media encodes instructions for caring out a method of obtaining and transmitting brief patient notes comprising the steps of:
supplying an account in an electronic health record to a first user;
providing health information about patients to the first user through a user interface;
receiving a request to enter a brief patient note through the user interface;
displaying a dialogue box through which the first user enters text to create a brief patient note; and
storing the brief patient note on the central repository.

6. The system for obtaining and transmitting brief patient notes over a computer network of claim 5 wherein the instructions for caring out a method of obtaining and transmitting brief patient notes further comprise the steps of:
supplying an account in an electronic health record to one or more second users;
displaying one more second users to the first user;
receiving selections of the one or more second users from the first user; and
displaying the brief patient note to the one or more second users selected by the first user.

7. The system for obtaining and transmitting brief patient notes over a computer network of claim 6 wherein the instructions for caring out a method of obtaining and transmitting brief patient notes further comprise the step of transmitting the brief patient note to the one or more second users by email.

8. The system for obtaining and transmitting brief patient notes over a computer network of claim 6 wherein the instructions for caring out a method of obtaining and transmitting brief patient notes further comprise the steps of:
creating an audit log of each user who accesses the brief patient note;
storing the audit log on the central repository; and
displaying the audit log to the first user through a user interface.
